(19) United States
(12) Patent Application Publication
(10) Pub. No.: US 2008/0148532 A1
(43) Pub. Date: Jun. 26, 2008

(54) WORM GEAR CLAMP WITH RETAINER

(75) Inventors: Edgardo Y. Estacio, Itasca, IL (US); Paul Gottemoller, Palos Park, IL (US)

Correspondence Address: INTERNATIONAL ENGINE INTELLECTUAL PROPERTY COMPANY, 4201 WINFIELD ROAD, P.O. BOX 1488, WARRENVILLE, IL, 60555, US

(73) Assignee: International Engine Intellectual Property Company , LLC, Warrenville, IL (US)

(21) Appl. No.: 11/613,778

(22) Filed: Dec. 20, 2006

(51) Int. Cl. F16L 3/00

(52) U.S. Cl. 24/274 R

(57) ABSTRACT

An apparatus (100) includes a clamp (114) having a head (116) and a worm gear (118) at least partially disposed in the head (116). The worm gear (118) is rotatable and has external threads. A strap (122) has a first end (128) attached to the clamp (114) and a second end (132) engaged by the worm gear (118). A retainer (146) is operably coupled to the head (116) and configured to attach the retainer (146) to a hose (12).

### FIELD OF THE INVENTION

The present invention relates generally to a clamp, including but not limited to an encircling, worm gear type clamp.

### BACKGROUND OF THE INVENTION

Worm gear clamps are widely used because they offer certain advantages over spring-type clamps or other types of clamps that are applicable to only a relatively narrow range of diameters. For example, worm gear clamps are more convenient to use because they do not require special tools for installation and removal. Further, worm gear clamps can be applicable to a larger range of diameters. Also, worm gear clamps allow adjustment of the clamping forces.

Typically, a free end of a strap member is introduced into a worm gear drive head, and into engagement with a worm member. Turning a worm member tightening screw reduces the diameter of the clamp. The worm member is typically turned by means of a screwdriver or wrench at a head of the worm member tightening screw.

However, the prior art worm gear clamps also involve some disadvantages. One disadvantage of the prior art worm gear clamps is that they are difficult to assemble onto a hose or other member. When the clamp is tightened, the tightening screw relocates from the original position to a second position. Thus, the user has to chase the tightening screw around the circumference of the hose during assembly onto the hose.

Further, in automotive applications, and particularly in engine assembly applications, an engine compartment has limited space in which the worm gear drive head can be located. In the limited space of the engine compartment, the manufacturing line user must anticipate where the worm gear drive head will relocate to after tightening the clamp. Requiring the manufacturing line user to anticipate the ending location, or to continually correct the ending location, of worm gear drive head is time consuming. Further, the precise location of the worm gear drive head must be known in an automated manufacturing line so that the automated machine knows the exact space that is occupied by the clamp.

Thus, there is a need for a worm gear clamp assembly that can be assembled onto a hose with ease. There is also a need for a worm gear clamp assembly that provides a precise known location of the clamp after installation.

### BRIEF SUMMARY OF THE INVENTION

An apparatus includes a clamp having a head and a worm gear at least partially disposed in the head. The worm gear is rotatable and has external threads. A strap has a first end attached to the clamp and a second end engaged by the worm gear. A retainer is operably coupled to the head and configured to attach the retainer to a hose.

### BRIEF DESCRIPTION OF THE SEVERAL VIEWS OF THE DRAWINGS

FIG. 1 is a perspective view of a prior art worm gear clamp and a prior art clamp retainer on a hose.

FIG. 2 is a perspective view of the prior art worm gear clamp and the clamp retainer of FIG. 1, with the worm gear clamp tightened.

FIG. 3 is a perspective view of a worm gear clamp assembly connected to an end of a hose, in accordance with the invention.

FIG. 4 is a perspective view of the worm gear clamp assembly of FIG. 3, with the worm gear clamp tightened, in accordance with the invention.

### DETAILED DESCRIPTION OF THE INVENTION

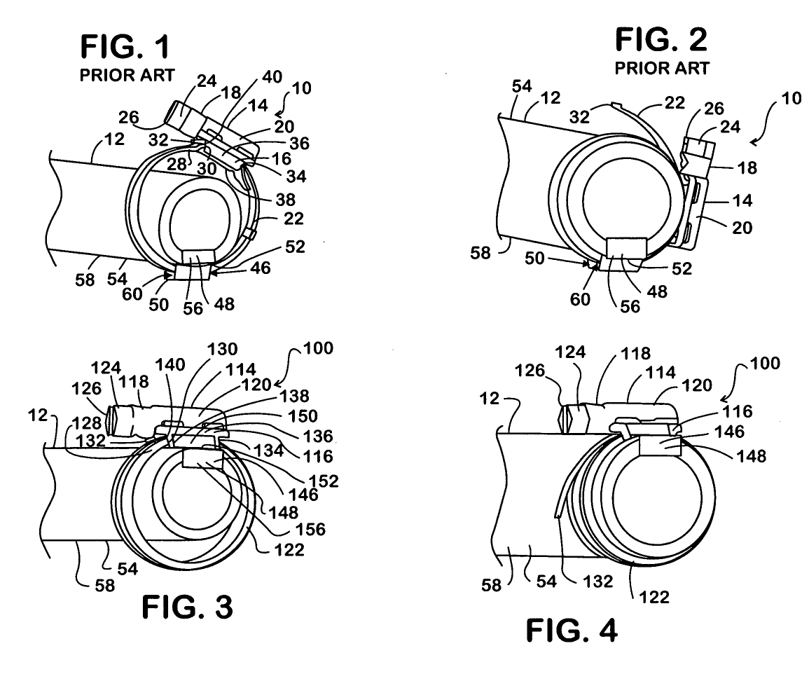

Referring now to FIGS. 1 and 2, a prior art worm gear clamp is depicted generally at 10, and is disposed on a hose 12. The worm gear clamp 10 includes a clamp 14 having a worm gear drive head 16 and a worm gear 18. The worm gear 18 is housed inside a worm gear housing 20. The clamp 14 receives a flexible strap member 22 that encircles the member to be clamped, such as the hose 12.

The worm gear 18 includes a set of external threads (not shown), and at the rearward end of the worm gear there is a head portion 24. The head portion 24 includes a slot 26 such that the worm gear 18 may be rotated with a screwdriver. A first end 28 of the strap member 22 is attached to the clamp 14 and extends from the worm gear drive head 16 at a first side 30. The strap member 22 extends around the circumference of the hose 12. A second end 32 of the strap member 22 is configured to be introduced into the worm gear drive head 16 at a second side 34.

The worm gear drive head 16 includes an outer wall 36, which defines a bottom surface 38 and the first and second sides 30, 34. The first and second sides 30, 34 also define an opening 40 that receives the strap member 22 and permits the strap member to move axially, or, tangentially, relative to the worm gear drive head 16. The outer wall 36, the bottom surface 38, and the first and second sides 30, 34 define a chamber (not shown) that receives the external threads (not shown) of the worm gear 18. Further, the chamber receives the strap member 22 after being introduced into the opening 40.

When the strap member 22 is in the chamber, it is engaged by the external threads of the worm gear 18. The external threads of the worm gear 18 are capable of pulling or pushing the strap member 22 through the worm gear drive head 16 when the worm gear 18 is rotated. The strap member 22 may advantageously include receiving formations or indentations (not shown) that align with and receive the threads of the worm gear 18.

Typically, a clamp retainer 46 is used with the clamp device 14 to maintain the clamp device on the circumference of the hose 12. The clamp retainer 46 includes a clamping portion 48 for attaching the clamp retainer 46 onto the hose 12, and a retaining portion 50 for attaching the clamp 14 to the clamp retainer. In the conventional clamp retainer 46, the clamping portion 48 has two opposing legs or teeth 52, between which a wall portion 54 of the hose 12 is introduced. A connecting surface 56 is generally perpendicular to the two opposing legs 52 to connect two opposing surfaces on the clamping portion 48 and the retaining portion 50.

The retaining portion 50 generally extends along an outside surface 58 of the wall portion 54 of the hose 12. The retaining portion 50 has a retaining structure 60 for fixing the strap member 22 on the hose 12. The retaining structure 60, in this example, is a flanged portion that permits the strap member to extend between the retaining portion 50 and the hose 12 such that the strap member is clamped to the hose.

The installation and use of the clamp 14 is depicted in FIGS. 1 and 2, where it can be seen that the clamp retainer 46 is fixed to the hose 12 and the strap member 22 is introduced into the retaining structure 60 of the clamp retainer either before or after the clamping portion 48 is attached to the hose. The second end 32 of the strap member 22 is introduced into the second side 34 of the worm gear drive head 16.

One disadvantage of the prior art configuration is that the location of the clamp 14 moves around the circumference of the hose 12 as the worm gear 18 is tightened. This is because the strap member 22 is secured to the hose 12 at the clamp retainer 46. Thus, when the worm gear 18 is tightened, the worm gear drive head 16 relocates from the original position (for example, generally above the hose 12) to a second position (for example, generally 90-degrees) as the clamping force is increased.

Referring now to FIGS. 3 and 4, the present worm gear clamp assembly is depicted generally at 100, and like components are designated with like numbers. The present worm gear clamp assembly 100 is generally similar to the conventional worm gear clamp 10. Advantageously, a clamp retainer 146 is attachable to or integral with a clamp 114 in the present worm gear clamp assembly 100. While a preferred embodiment of the clamp 114, clamp retainer 146, and a strap member 122 are presented, it should be appreciated that the present worm gear clamp assembly should not be limited to the particular configurations shown.

The worm gear clamp assembly 100 includes the clamp 114 having a worm gear drive head 116 and a worm gear 118. Preferably, at least a portion of the worm gear 118 is housed inside a worm gear housing 120. The clamp 114 receives a flexible strap member 122 that encircles a hose 12.

The worm gear 118 includes a set of external threads (not shown), and a head portion 124. The head portion 124 may advantageously include a feature that is arranged to interface with a tool. In this embodiment, for example, the head portion 124 includes a slot 126 that enables rotation of the worm gear 118 with a screwdriver. Other configurations that permit turning of the worm gear by means of one's hands or any tool are may also be used.

A first end 128 of the strap member 122 is attached to the clamp 114 at the worm gear drive head 116 and extends from the worm gear drive head at a first side 130. The strap member 122 extends around the circumference of the hose 12. A second end 132 of the strap member 122 passes through the worm gear drive head 116 at a second side 134. It is contemplated that the worm gear drive head 116 and the strap member 122 may be assembled in one-piece or in multiple pieces.

The worm gear drive head 116 includes an outer wall 136 that defines a bottom surface 138, and the first and second sides 130, 134. The bottom surface 138 is advantageously curved in a concave fashion to conform with the curved or circular outer contour of the hose 12.

The first and second sides 130, 134 define an opening 140 that receives the strap member 122 and permits the strap member to move axially, or tangentially, relative to the worm gear drive head 116. The outer wall 136, the bottom surface 138, and the first and second sides 130, 134 define a chamber (not shown) that receives the external threads (not shown) of the worm gear 118. Further, the chamber receives the strap member 122 after the strap member 122 has been inserted through the opening 140. In this embodiment, the second end 132 of the strap member 122 is introduced into the chamber between the bottom surface 138 and the worm gear 118. Alternatively, the first end 128 of the strap member 122 may be attached to the bottom surface 138, and the second end 132 of the strap member may be inserted through the worm gear drive head 116 between the first end of the strap member and the worm gear.

When the strap member 122 is disposed in the chamber, it is advantageously engaged by the external threads of the worm gear 118. The strap member 122 may includes a receiving formation, or a set of dents (not shown) that are arranged to align with and receive the threads of the worm gear 118. When the worm gear 118 is rotated, the external threads thereof that engage the receiving formation may act thereon to push or pull the strap member through the worm gear drive head 116 to, respectively, loosed or tighten the clamp 114.

In the worm gear clamp assembly 100, the clamp retainer 146 is fixed to the clamp 114. The clamp retainer 146 includes a clamping portion 148 that has two opposing legs 152 configured to receive a wall 54 of the hose 12. A connecting surface 156 may advantageously be generally perpendicular to the two opposing legs 152, to connect the two opposing surfaces, but other configurations may be used.

A retaining portion 150 of the clamp retainer 146 connects the clamp retainer to the clamp 114, advantageously, at the worm gear drive head 116. In the embodiment shown, the retaining portion 150 is integrally molded to the outer wall 136 of the worm gear drive head 116. Alternatively, the clamp retainer 146 may be connected to the clamp 114. Further, the clamp retainer 146 may be attachable to the clamp 114 such as, for example, with a mechanical interlocking structure. Generally, any configuration of the retainer clamp 146 that both clamps onto the hose 12 and connects to the clamp 114 to fix the location of the clamp device relative to the hose is contemplated.

The worm gear clamp assembly 100 is shown in a loosened position in FIG. 3. The clamp retainer 146 is attached to the hose 12 and the second end 132 of the strap member 122 is introduced into the opening 140 on the second side 134 of the worm gear drive head 116. The strap member 122 can be introduced into the opening 140 either before or after the clamping portion 148 is attached to the hose 12.

As seen in FIG. 4, when the worm gear 118 is tightened, the worm gear drive head 116 does not relocate. That is, when the worm gear 118 is tightened or loosens to allow the strap member 122 to pass through the worm gear drive head 116, the clamp 114 does not move (or moves minimally) from its original position relative to the hose 12. Instead, the strap member 122 moves tangentially relative to the stationary worm gear drive head 116, while the worm gear drive head 116 remains substantially stationary relative to the hose 12.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. An apparatus comprising:
a clamp including a head and a worm gear at least partially disposed in the head, the worm gear being rotatable and having external threads;
a strap having a first end attached to the clamp and a second end engaged by the worm gear; and
a retainer operably coupled to the head and configured to attach the retainer to a hose.

2. The apparatus of claim 1, wherein when the second end of the strap is engaged with the worm gear, and when the worm gear is rotated, the clamp remains stationary with respect to the hose.

3. The worm gear clamping assembly of claim 1, wherein the retainer comprises two opposing legs configured to engage a wall portion of the hose.

4. The worm gear clamping assembly of claim 1, wherein the retainer is integral to the clamp.

5. The worm gear clamping assembly of claim 1, wherein the retainer is attachable to the head of the clamp.

6. The worm gear clamping assembly of claim 1, wherein the strap includes a receiving formation that engages the external threads of the worm gear.

7. The worm gear clamping assembly of claim 1, wherein the head includes a chamber for receiving the second end of the strap, wherein at least a portion of the worm gear is disposed in the chamber, and wherein the strap is capable of moving relative to the head when the worm gear is rotated.

8. An apparatus comprising:
a clamp including a head and a worm gear at least partially disposed in the head, the worm gear being rotatable and having external threads;
a strap having a first end attached to the clamp and a second end for being engaged and driven by the worm gear in the worm gear drive head;
wherein before the strap is driven by the worm gear, the clamp is located in a first position relative to a hose, and wherein after the strap is driven by the worm gear, the clamp remains in the first position relative to the hose.

9. The worm gear clamping assembly of claim 8, further comprising a retainer operably coupled to the head and attached to the hose.

10. The worm gear clamping assembly of claim 8, wherein the retainer comprises two opposing legs configured to clamp a wall portion of the member.

11. The worm gear clamping assembly of claim 9, wherein the retainer is integral to the clamp.

12. The worm gear clamping assembly of claim 9, wherein the retainer is attachable to the clamp.

13. The worm gear clamping assembly of claim 8, wherein the strap includes a receiving formation that is configured for engagement with the external threads of the worm gear.

14. A worm gear clamping assembly for clamping a hose, comprising:
a clamp including a worm gear drive head defining a chamber, and a worm gear at least partially disposed in the chamber, the worm gear having external threads and a portion for rotating the worm gear;
a strap member having a first end attached to the clamp and a second end having a receiving formation for being engaged by and driven by the external threads of the worm gear, wherein the second end is received in the chamber of the worm gear drive head; and
a clamp retainer fixed to the clamp, the clamp retainer including a clamping portion configured to attach the clamp retainer to the hose, the clamping portion having two opposing legs configured to engage two sides of a wall of the hose.

15. The worm gear clamping assembly of claim 14, wherein when the second end of the strap member is engaged with the worm gear, and when the worm gear is rotated, the worm gear drive head remains stationary with respect to the hose.

16. The worm gear clamping assembly of claim 14, wherein the clamp retainer is integral to the worm gear drive head.

17. The worm gear clamping assembly of claim 14, wherein the clamp retainer is attachable to the worm gear drive head.

18. The worm gear clamping assembly of claim 14, wherein the worm gear drive head has a bottom surface that is curved to generally conform to the curved surface of the hose.

19. The worm gear clamping assembly of claim 14, wherein the clamp retainer is connected to the clamp at an outer wall of the worm gear drive head.

20. The worm gear clamping assembly of claim 19, wherein the outer wall defines an opening for the chamber.
